(19) United States
(12) Patent Application Publication
(10) Pub. No.: US 2007/0135122 A1
(43) Pub. Date: Jun. 14, 2007

(54) System and method for providing coverage to mobile stations in a network

(76) Inventors: Matt J. Dillon, Hawthorn Woods, IL (US); Thomas K. Appiah, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/301,128

(22) Filed: Dec. 12, 2005

(51) Int. Cl. H04Q 7/20

(52) U.S. Cl. 455/433

(57) ABSTRACT

A received signal strength indicator (RSSI) value associated with a communication is determined (202). The communication is being conducted at a first frequency band. The RSSI value is compared to a high threshold and a low threshold (203). Based upon the comparing, the transfer of the communication to a second frequency band is selectively caused to occur (204, 206, 208).

### FIELD OF THE INVENTION

The field of the invention relates to the transmission of communications in networks and, more specifically, to maintaining communications with mobile stations as the mobile stations move through networks.

### BACKGROUND OF THE INVENTION

Mobile stations often move within and between a variety of different environments and/or networks. For example, a user may operate a mobile station in their vehicle as the vehicle moves through different environments such as along open highways or in confined urban areas. In another example, users utilize their mobile stations when situated in buildings, tunnels, trains, or other confined or obstructed areas. The operation of the mobile station is often affected by the type of environment in which the mobile station is operating. For instance, the mobile station may experience varying reception quality as it moves between various areas of a building or as it moves from an urban setting to a non-urban setting.

In one specific example, in-building operations of mobile stations often suffer from coverage holes. For instance, in some situations, greater than 6 db of loss is suffered when a mobile station is operating in a building and the mobile station moves from one coverage area to another coverage area. Under these types of conditions, mobile stations typically drop their calls unless an approach is provided to transfer the call to a different operating frequency.

In some previous systems, a decision was made to hand over a mobile station to a particular cell based upon the position, velocity, or direction of motion of a mobile station. However, this approach was not useful when the mobile station entered a building, which had a coverage area much smaller than a single communication cell. In other previous approaches, mobile stations were provided that used multiple frequency bands for communications. However, although the use of multiple frequency bands was supported, these previous approaches did not automatically use the best band for given environmental conditions. Consequently, such previous approaches proved inadequate for handling communications in certain coverage areas such as within buildings and other enclosed locations. Dropped calls continued in these previous systems, thereby decreasing system efficiency and increasing user frustration with the system.

### BRIEF DESCRIPTION OF THE DRAWINGS

FIG. 1 is a block diagram of a system for adjusting the operating frequency band of a communication and/or self-tuning the high and low thresholds used to determine a transfer according to the present invention;

FIG. 2 is a flow chart of an approach for adjusting the frequency band of a communication according to the present invention;

FIG. 3 is a flow chart of an approach for self-tuning high and low thresholds according to the present invention; and

FIG. 4 is a block diagram of a device for adjusting the operating frequency band of a communication and/or self-tuning the high and low thresholds according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method whereby, under appropriate conditions, a communication operating within an initial frequency band is transferred to a different frequency band. Consequently, continuity of communications is maintained as a mobile station moves between different operating environments or locations. The implementation of the approaches described herein can result in communications not being as readily dropped when mobile stations enter difficult operating environments such as locations within buildings and other confined or obstructed areas.

In many of these embodiments, a received signal strength indicator (RSSI) value associated with a communication is determined for a communication using a first frequency band. The RSSI value is compared to a high threshold and a low threshold. Based upon the comparing of the RSSI value to the high and low thresholds, the transfer of the communication to a second frequency band is selectively caused to occur. For instance, the communication may be transferred to the higher frequency band when the RSSI value exceeds the high threshold. Alternatively, the communication may be transferred to the lower frequency band occurs when the RSSI value is determined to be less than the low threshold.

In others of these embodiments, the high and low threshold values are self-tuned. The amount of self-tuning may be based upon a number of factors. For example, the self-tuning may be based upon a physical layer measurement or a key performance indicator. More specifically, the self-tuning may be based upon the ratio of a pilot signal strength to interference (Ec/Io), any key performance indicator, the Periodic Pilot Signal Strength Measurement (PPSSM), the forward Frame Erasure Rate (FER), the reverse FER, the reverse rise, the Outer Loop Threshold (OLT), the Traffic Channel (TCH) gain, or the content of a Call Detail Log (CDL). Other factors may also be used for the self-tuning of the thresholds.

Thus, a system and method is described whereby under appropriate conditions, a communication, such as a call, is transferred from an initial frequency band to a different frequency band based upon the operating conditions encountered by a mobile station. The implementation of the approaches described herein can result in communications not being as readily dropped when mobile stations enter difficult operating environments such as buildings or other confined or obstructed locations.

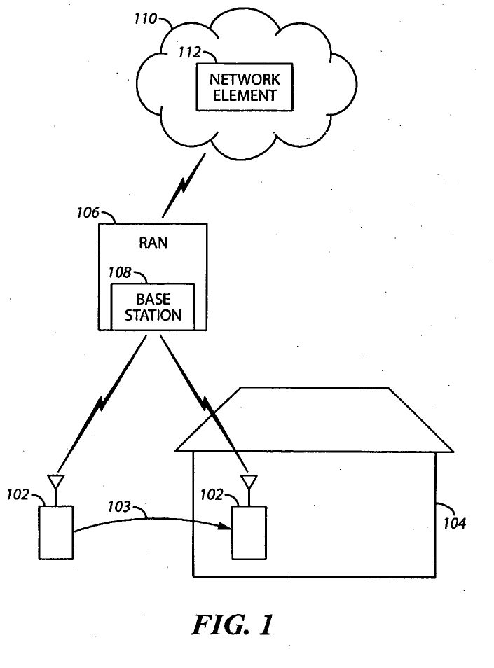

Referring now to FIG. 1, one example of a system for determining the frequency band to-be-used by a communication and for self-tuning the thresholds used to determine the frequency band is described. As shown, a mobile station 102 operates both inside and out side of a building 104. The mobile station 102 may be any type of mobile wireless device. For example, the mobile station 102 may be a cellular telephone, a pager, a personal computer, or a personal digital assistant (PDA). Other examples of mobile stations are possible.

The building 104 may be any type of structure such that the operating conditions in the building are different and may be worse than the operating conditions outside of the building 104. Although the following description is made in terms of the mobile station 102 operating both inside and outside of a building, it will be appreciated that the principles described herein apply to all types of operating environments that possess varied operating conditions. For instance, the principles described herein apply to mobile stations operating in buildings, tunnels, highways, overpasses, airplanes, trains, or under various weather and other environmental conditions. Other examples of operating environments are possible.

A Radio Access Network (RAN) 106 is coupled to a network 110. The RAN 106 includes elements that receive communications and transmit communications from mobile stations, for instance, a base station 108. In addition, other elements may be included in the RAN 106. These elements are well known to those skilled in the art and will not be discussed in greater detail here.

The network 110 may include a variety of elements such as a network element 112. The network element 112 may be a controller, switch, gateway, server, or any other type of network element. The network 110 may be any type of network or combination of networks such as a cellular network, a Push-to-Talk (PTT) network, a packet network, or a conventional telephone network.

In one example of the operation of the system of FIG. 1, the mobile station is initially operating outside of the building 104 and moves inside of the building 104 as indicated by an arrow 103. The mobile station 102 transmits information to the base station 108 in the RAN 106. This information includes a Received Signal Strength Indicator (RSSI). The RSSI value may be contained in a message received from the mobile station 102 such as a Periodic Pilot Strength Measurement Message (PPSMM).

The communication is being conducted at a first frequency band. The RSSI value associated with the communication is compared to a high threshold and a low threshold. Based upon comparing the RSSI value to the thresholds, the transfer of the communication to a second frequency band is selectively caused to occur by the base station 108. More specifically, the RSSI value may be compared to high and low thresholds and the frequency band adjusted based upon the comparison.

For example, if the RSSI value exceeds the high threshold, the communication may be switched to a higher frequency band. On the other hand, if the RSSI value is less than the low threshold, the communication may be switched to a lower frequency band. Finally, if the RSSI value is between the high and low thresholds, the system may wait to receive the next PPSMM message and evaluate the next RSSI value.

Initial values for high and low thresholds are determined through walk testing in representative environments. For example, field testing has determined the higher threshold to be nominally −75 dBm and the lower threshold to be −95 dBm. The settings can be initialized in this manner, however, the systems can be tuned with higher loading as the offsets will shift load between the frequency bands depending on the exact settings and user in/out of building distributions.

Additionally, the high and low thresholds may be self-tuned by the base station 108. The self-tuning may be accomplished and based upon a number of factors. For instance, the self-tuning may be based upon a physical layer measurements or key performance indicators. More specifically, the self-tuning may be based upon the ratio of the pilot signal strength to interference (Ec/Io), any key performance indicator, the Periodic Pilot Signal Strength Measurement (PPSSM), the forward Frame Erasure Rate (FER), the reverse FER, the reverse rise, the Outer Loop Threshold (OLT), the Traffic Channel (TCH) gain, or the content of a Call Detail Log (CDL).

In one example, the self-tuning may seek to reduce the value of a cost function. For instance, the following cost function may be used:
Cost=(X*(number/time of a Candidate Frequency Search(CFS)+Y* (PPSM rate)+W*(traffic shift out speed*Z*(hand down failure rate of a Key Performance Indicator))
where W, X, Y, and Z are weighting factors. The cost function is used to determine whether to adjust the high and low thresholds.

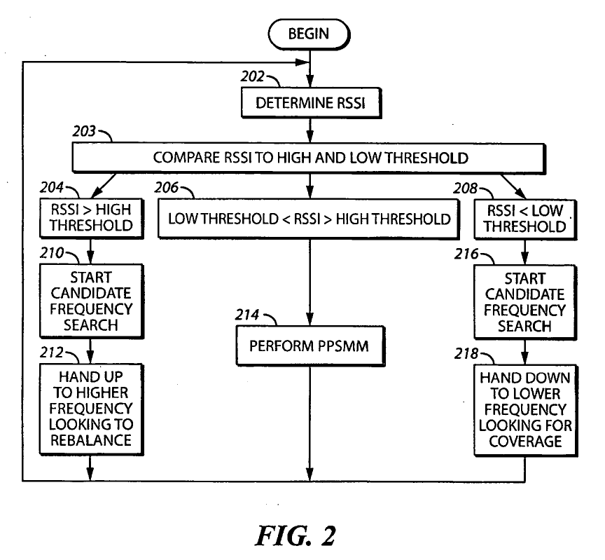

Referring now to FIG. 2, one example of an approach for adjusting the frequency band of a communication is described. At step 202, a Received Signal Strength Indicator (RSSI) is received. For instance, a message may be received from a mobile station with this value included and the value may be extracted from the message.

At step 203, the RSSI value is compared to high and low thresholds and at steps 204, 206, and 208 different paths are undertaken with the selection of the particular path based upon the results of the comparison.

For instance, step 204 is reached if it is determined that the RSSI value is greater than the high threshold. Consequently, at step 210, a candidate frequency search is performed to ensure that a frequency band is available for the transfer. At step 212, the communication is handed up to the higher frequency to rebalance the load on each frequency. Control then continues with step 202 as described above.

Step 206 is reached if it is determined that the RSSI value is greater than the low threshold but less than the high threshold. Consequently, at step 214 the system waits to receive another PPSMM message (or other indication), including the RSSI value. Control then returns to step 202 as described above.

Step 208 is reached if it is determined that the RSSI value is greater than the high threshold. Consequently, at step 216, a candidate frequency search is performed to determine if a suitable frequency band is available. At step 218, after the frequency band is identified, the communication is handed down to the frequency band.

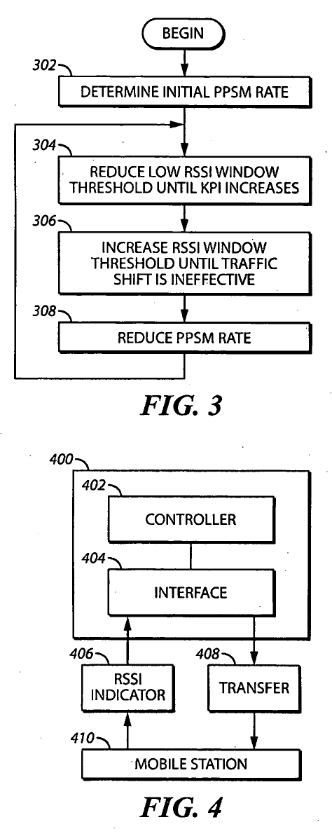

Referring now to FIG. 3, one example of an approach for self-tuning the high and low thresholds previously mentioned is described. The self-tuning determines the frequency of taking the RSSI measurement. The self-tuning involves adjusting the Periodic Pilot Signal Strength Measurement Message (PPSMM) periodic rate, and/or the high and low thresholds.

At step 302, the PPSMM message rate is initially set. Preferably, this is set to a fast rate such as 1-2 seconds. In another example, a slower rate of 10-20 seconds may be used. At step 304, the low threshold is reduced until a Key Performance Indicator (KPI) increases. For instance, the low threshold may be reduced until the hand-off success rate as measured by the system increases.

At step 306, the high threshold is increased until the traffic shift out is ineffective. At step 308, the PPSMM rate is reduced. For example, the rate may be reduced by a value such as 10 percent. Control then continues at step 304 as described above.

Referring now to FIG. 4, one example of a device 400 for adjusting the frequency of bandwidth of operation of a mobile station and/or self-tuning thresholds used in the adjustment of the frequency is described. The device 400 includes a controller 402 and an interface 404. The interface allows the controller 402 to communicate with a mobile station 410.

A received signal strength indicator (RSSI) value 406 that is associated with a communication that is being conducted at a first frequency band may be received at the interface device 404. The controller 402 is programmed to compare the RSSI value 404 to a high threshold and low threshold and, based upon the comparing, selectively transferring the communication to be made at a second frequency band. This may be accomplished by sending a control message 408 to the mobile station 410. In one example, this may be accomplished using existing PPSMM messages.

The controller 402 may be programmed to self-tune the high and low thresholds that are used to determine a frequency band adjustment. The high threshold and the low threshold may be self-tuned based upon physical layer measurements or key performance indicators. More specifically, and as mentioned previously, the high threshold and the low threshold may be self-tuned according to ratios of a pilot signal strength to interference (Ec/Io), key performance indicators, Periodic Pilot Signal Strength Measurements (PPSSMs), forward Frame Erasure Rates (FERs), reverse FERs, reverse rises; Outer Loop Thresholds (OLTs), Traffic Channel (TCH) gains, or contents of Call Detail Logs (CDLs).

Thus, a system and method is described whereby under appropriate conditions, a frequency of a communication, such as a call, is transferred to a different frequency band. The approaches described herein are easy to implement and result in communications not being dropped when mobile stations enter certain confined environments such as buildings.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for improving coverage for users in a communication system comprising:
determining a received signal strength indicator (RSSI) value associated with a communication, the communication being conducted at a first frequency band;
comparing the RSSI value to a high threshold and a low threshold; and
based upon the comparing, selectively causing the transfer of the communication to a second frequency band.

2. The method of claim 1 wherein selectively causing the transfer of the communication to the second frequency band comprises enabling a candidate frequency measurement.

3. The method of claim 1 wherein selectively causing the transfer of the communication to the second frequency band comprises transferring the communication to the second frequency band when the RSSI value exceeds the high threshold.

4. The method of claim 1 wherein selectively causing the transfer of the communication to the second frequency band comprises transferring the communication to the second frequency band when the RSSI value is less than the low threshold.

5. The method of claim 1 further comprising self-tuning a frequency band at which the RSSI value is determined.

6. The method of claim 1 further comprising self-tuning the high threshold and the low threshold.

7. The method of claim 6 wherein the self-tuning is accomplished and based upon at least one factor selected from a group comprising: a ratio of a pilot signal strength to interference (Ec/Io); a key performance indicator; a Periodic Pilot Signal Strength Measurement (PPSSM); a forward Frame Erasure Rate (FER); a reverse FER; a reverse rise; an Outer Loop Threshold (OLT); a Traffic Channel (TCH) gain; and a content of a Call Detail Log (CDL).

8. The method of claim 6 wherein the self-tuning is accomplished and based upon one factor selected from a group comprising a physical layer measurement and a key performance indicator.

9. A method for improving coverage for users in a communication system comprising:
determining a received signal strength indicator (RSSI) value associated with a communication, the communication being conducted at a first frequency band;
comparing the RSSI value to a high threshold and a low threshold;
selectively transferring the communication to the second frequency band comprises transferring the communication to the second frequency band when the RSSI value exceeds the high threshold;
selectively transferring the communication to a second frequency band comprises transferring the communication to the second frequency band when the RSSI value is less than the low threshold; and
automatically self-tuning the high threshold and the low threshold.

10. The method of claim 9 further comprising self-tuning a frequency band at which the RSSI value is determined.

11. The method of claim 9 wherein the self-tuning is accomplished and based upon at least one factor selected from a group comprising: a ratio of a pilot signal strength to interference (Ec/Io); a key performance indicator; a Periodic Pilot Signal Strength Measurement (PPSSM); a forward Frame Erasure Rate (FER); a reverse FER; a reverse rise; an Outer Loop Threshold (OLT); a Traffic Channel (TCH) gain; and a content of a Call Detail Log (CDL).

12. The method of claim 9 wherein the self-tuning is accomplished and based upon one factor selected from a group comprising a physical layer measurement and a key performance indicator.

13. A system for improving coverage for users in a communication system comprising:
a interface device having an input to receive a received signal strength indicator (RSSI) value that is associated with a communication that is being conducted at a first frequency band; and
a controller coupled to the interface device, the controller programmed to compare the RSSI value to a high threshold and low threshold and, based upon the comparing, selectively transferring the communication to be made at a second frequency band.

14. The system of claim 13 wherein the controller is further programmed to self-tune a frequency band at which the RSSI value is determined.

15. The system of claim 13 wherein the controller is further programmed to self-tune the high threshold and the low threshold.

16. The system of claim 15 wherein the high threshold and the low threshold are self-tuned according to at least one factor selected from a group comprising: a ratio of a pilot signal strength to interference (Ec/Io); a key performance indicator; a Periodic Pilot Signal Strength Measurement (PPSSM); a forward Frame Erasure Rate (FER); a reverse FER; a reverse rise; an Outer Loop Threshold (OLT); a Traffic Channel (TCH) gain; and a content of a Call Detail Log (CDL).

17. The system of claim 15 wherein the high threshold and the low threshold are self-tuned according to at least one factor selected from a group comprising a physical layer measurement and a key performance indicator.
